(19) United States
(12) Patent Application Publication
(10) Pub. No.: US 2017/0267382 A1
(43) Pub. Date: Sep. 21, 2017

(54) ARRANGEMENT FOR CLOSING A FILLING OPENING IN A BASE OF A BEVERAGE CONTAINER

(71) Applicant: MartinMechanic Friedrich Martin GmbH &Co. KG, Nagold (DE)

(72) Inventor: Claus Martin, Nagold (DE)

(21) Appl. No.: 15/462,867

(22) Filed: Mar. 19, 2017

(30) Foreign Application Priority Data
Mar. 21, 2016 (DE) DE102016105204.3
Apr. 19, 2016 (DE) DE102016107219.2

(51) Int. Cl. B65B 7/28; B65B 3/04

(52) U.S. Cl. CPC B65B 7/2807; B65B 3/04; F26B 3/04

(57) ABSTRACT

An arrangement for closing a filling opening in a base of a beverage container that is open on top, the arrangement including a magazine which includes closures for the filling opening; an emptying device which unloads the closures individually from the magazine; and the beverage container, wherein the beverage container is arranged so that an upper opening of the beverage container is positioned under the emptying device so that the beverage container is in contact with the emptying device so that the emptying device is displaceable together with the beverage container so that the emptying device unloads an individual closure from the closures from the magazine and the individual closure drops into the beverage container under the emptying device.

### RELATED APPLICATIONS

This application claims priority from and incorporates by reference German patent application
DE 10 2016 105 204.3 filed on Mar. 21, 2016 and
DE 10 2016 107 219.2 filed on Apr. 19, 2016.

### FIELD OF THE INVENTION

The invention relates to an arrangement for closing a filling opening in a base of a beverage container that is open on top.

### BACKGROUND OF THE INVENTION

US patent application publication 2011/0121020 A1 discloses a device for filling a beverage container that is open on top like e.g. a cup or a beverage glass from below through a filling opening in a center of a base of the beverage container. The filling opening is enveloped by an annular magnet which holds a ferromagnetic disc on the filling opening that functions as a closure. For filing the beverage container is placed onto a hollow shaft which lifts the disc off from the filling opening and which includes lateral outlet openings for a liquid to be filled into the beverage container. After filling the beverage container is lifted off from the hollow shaft and the disc moves back onto the annular magnet and closes the filling opening in the base of the beverage container.

### BRIEF SUMMARY OF THE INVENTION

Thus, it is an object of the invention to propose an arrangement which arranges a disc or generally speaking a closure on a filling opening in a base of a beverage container that is open on top, for example a beverage glass or a cup. “On top” designates a side of the beverage container that is arranged opposite to a base of the beverage container and which is arranged on top when the beverage container is being used, thus the beverage container includes a liquid or drinking is performed from the full beverage container.

The object is achieved by An arrangement for closing a filling opening in a base of a beverage container that is open on top, the arrangement including a magazine which includes closures for the filling opening; an emptying device which unloads the closures individually from the magazine; and the beverage container, wherein the beverage container is arranged so that an upper opening of the beverage container is positioned under the emptying device so that the beverage container is in contact with the emptying device so that the emptying device is displaceable together with the beverage container so that the emptying device unloads an individual closure from the closures from the magazine and the individual closure drops into the beverage container under the emptying device.

The arrangement according to the invention includes a magazine and an emptying device. A beverage container that is open on top for drinking and includes a filling opening in the base is part of the arrangement in embodiments of the invention. The filling opening is advantageously but not necessarily arranged in a center of the base of the beverage container. The magazine includes closures for closing the filling opening in the base of the beverage container. Advantageously the closures are provided stacked in the magazine. In an upright or slanted magazine the closures move downward towards the emptying device following gravity. It is also possible to move the closures in another way, for example with a spring element in the magazine to the emptying device. This facilitates to arrange the magazine in any direction.

The emptying device unloads the closures individually from the magazine and can thus also be designated as an individualizer. The emptying device is driven or moved together with the beverage container. Thus, the beverage container is arranged with its upper opening facing upward under the emptying device so that the beverage container is in contact with the emptying device so that moving the beverage container drives or moves the emptying device. It is provided in particular that the beverage container is held by hand when arranging it under the emptying device. By moving the beverage container by hand the emptying device can be driven or moved so that the emptying device unloads a closure out of the magazine which drops following gravity into the beverage container which is supported below the emptying device or arranged in another manner below the emptying device. The closure drops onto the filling opening in the base of the beverage container an closes the filling opening.

The arrangement according to the invention facilitates quick and reliable closure of the filling opening in the base of a beverage container which includes a disc or similar as a closure. Thus, it is possible to operate the arrangement exclusively by moving the beverage container which facilitates one hand operation.

Advantageously the magazine is replaceable so that an empty magazine can be replaced with a full magazine quickly and full magazines can be prepared.

An embodiment of the invention provides that an ejection opening of the emptying device is arranged above the filling opening in the base of the beverage container that is arranged under the emptying device in an ejection position of the emptying device. When unloading the magazine with the emptying device a closure exits individually from the outlet opening of the emptying device or falls individually out of the emptying device in the ejection position of the emptying device. When the beverage container is arranged in a predetermined position and orientation under the emptying device the filling opening in the base of the beverage container is positioned under the ejection opening so that the closure drops onto the filling opening. When a closure drops vertically out of the ejection opening the filling opening is arranged vertically under the ejection opening. When a closure has a horizontal velocity when it drops out of the ejection opening and the closure therefore drops downward from the ejection opening with a parabolic trajectory the ejection opening has a respective lateral offset from the filling opening in the base of the beverage container that is arranged or supported under the emptying device.

An embodiment of the invention provides that the emptying device includes an unloading slide which unloads a closure from the magazine and lets it drop out of the ejection opening when the unloading slide is moved from a base position into an ejection position. The unloading slide is moved together with the beverage container which is thus arranged under the unloading slide, e.g. supported by hand so that the beverage container is in contact with the unloading slide so that the unloading slide is slideable together with the beverage container. Thus, the beverage container that is in contact with the unloading slide is moved in a movement direction of the unloading slide.

An embodiment of the invention provides a contact surface at a bottom side of the unloading slide for an edge of the upper opening of the beverage container. When the edge of the upper opening of the beverage container contacts the contact surface at the bottom side of the unloading slide the unloading slide is movable due to friction between the edge of the upper opening of the beverage container and the contact surface at the bottom side of the unloading slide by moving the beverage container in the movement direction of the unloading slide so that a closure is unloaded from the magazine onto the filling opening in the base of the beverage container.

An embodiment of the invention provides a rectangular tubular unloading slide in which a base of the magazine is arranged that is fixed in place relative to the magazine. The base keeps the closures in the magazine and by moving the unloading slide from a base position into an ejection position a closure is unloadable individually out of the magazine along the base of the magazine.

An embodiment of the invention provides that the unloading slide includes an ejection opening for a closure for the filling opening of the beverage container. The ejection opening advantageously corresponds to the closure and positions the closure during unloading from the magazine so that the closure drops onto the filling opening in the base of the beverage container. In the starting position the ejection opening of the unloading slide coincides with an outlet opening of the magazine so that a closure is arranged in the injection opening of the unloading slide. The filling opening in the base of the beverage container is arranged under the ejection opening of the unloading slide so that a closure drops out of the ejection opening in the ejection position of the unloading slide onto the filling opening in the base of the beverage container and closes the filling opening.

An embodiment of the invention provides an unloading slide with two ejection openings wherein one ejection opening coincides with the outlet opening of the magazine in a first position of the unloading slide and a second ejection opening coincides with the outlet opening of the magazine in a second position of the unloading slide. The two positions of the unloading slide are for example end positions between which the unloading slide is slideable back and forth. The respective other ejection opening of the unloading slide is laterally offset from the outlet opening of the magazine in an ejection position in which a closure drops from the ejection opening of the unloading slide onto the filling opening in the base of the beverage container. The beverage container is arranged or supported under the ejection opening of the unloading slide which is positioned under the outlet opening of the magazine. When the unloading slide is moved into a different position by moving the beverage container the unloading slide unloads an individual closure laterally from the magazine in an ejection opening and subsequently lets the closure drop onto the filling opening in the base of the beverage container. During this movement the other ejection opening of the unloading slide moves under the outlet opening of the magazine so that the next lowest closure moves into the ejection opening. Another beverage container on whose filling opening no closure is arranged yet is arranged under the ejection opening of the unloading slide which is arranged under the outlet opening of the magazine. Opposite sliding of the unloading slide moves the closure out of the magazine and lets it drop onto the filling opening of the beverage container.

In an embodiment of the invention the emptying device or the unloading slide includes a driver at a base wherein the beverage container laterally contacts the driver to move the emptying device or move the unloading slide. The driver facilitates moving the emptying device or sliding the unloading slide with the beverage container because the movement is not only transmitted by friction but by form locking of the beverage container on the emptying device or the unloading slide. Furthermore the driver functions as a lateral support for the beverage container which facilitates positioning the beverage container so that the filling opening in the base of the beverage container is arranged under the closure and the closure drops from the magazine onto the filling opening during unloading,

An embodiment of the invention provides a positioning device which positions the beverage container relative to the emptying device, the unloading slide and/or relative to the ejection opening. For example the positioning device positions a beverage container that is arranged under the unloading slide in a direction transversal to a movement direction of the unloading slide. The driver can simultaneously form the positioning device in that it envelops for example the beverage container at a circumferential section wherein the beverage container is arranged under the driver or in that the driver is only configured at individual locations, for example two locations that are offset from each in a circumferential direction of the beverage container.

In order to arrange the beverage container under the emptying device or under the unloading slide in a predetermined position, for example in lateral contact with its upper edge at a driver, the beverage container in an embodiment of the invention is supported by hand and moved by hand in order to operate the arrangement according to the invention. This embodiment of the invention facilitates an arrangement according to the invention that is easily operable by one hand.

It is possible for the closure to be loosely arranged on the filling opening in the base of the beverage container. For example for lateral fixation the closure can engage a bead collar of similar externally that envelops the filling opening or the closure can reach into the filling opening. An embodiment of the invention provides that the closure is magnetically supported on the filling opening. Thus, for example an edge of the filling opening and/or the closure is magnetic or ferromagnetic. Other options to fixate the closure on the filling opening in the base of the beverage container are not excluded.

An embodiment of the invention provides a cleaning device and/or a drying device for the closures. The cleaning device can for example include a bath or a spraying device which cleans the closures with water or a cleaning liquid. The drying device can dry the cleaned closures for example with hot air or by infrared induction or another type of heating. The cleaning device and/or the drying device are arranged in particular between the magazine and an ejector of the arrangement which ejects the closures into the beverage container, wherein the drying device is arranged downstream of the cleaning device. The limitation “between” is not so much three dimensional but rather relates to a path that is traveled by the closures from the magazine to the filling opening in the base of the beverage container.

### BRIEF DESCRIPTION OF THE DRAWINGS

The invention is subsequently described with reference to an embodiments illustrated in the drawing figure, wherein:

FIG. 1 illustrates an arrangement according to the invention in a axial and longitudinal sectional view in a starting position;

FIG. 2 illustrates the arrangement of FIG. 1 in an ejection position;

FIGS. 3-5 illustrates three additional embodiments of the invention in axial and longitudinal sectional views.

### DETAILED DESCRIPTION OF THE INVENTION

The figures illustrate schematic simplified depictions to enhance comprehension of the invention.

The arrangement 1 according to the invention illustrated in the drawing figure facilitates closing a filling opening 2 in a base 3 of a beverage container 4 that is open on top which is a drinking glass in the embodiment. The arrangement 1 includes a magazine 5 and an emptying device 6 including an unloading slide 7. The beverage container 4 can also be perceived as a component of the arrangement 1.

The magazine 5 is circular and tubular and arranged vertical in the embodiment. The magazine 5 includes circular disc shaped closures 8 for example made from steel or another ferromagnetic material which are stacked in the magazine 5. Through the vertically standing arrangement of the magazine 5 the closures 8 move downward in the magazine 5 following gravity. The magazine 5 has a fixed base 9 on which a lowest closure 8 rests. Between the base 9 and the magazine 5 the circular tubular magazine 5 includes a gap 10 which is slightly taller than a thickness of the closures 8 so that a respective closure 8 can be pushed through the gap 10 out of the magazine 5 which is also designated as unloading the magazine 5. The magazine 5 is exchangeable and can be quickly replaced with a full or partially filled magazine 5 after complete or partial unloading.

In the embodiment the unloading slide 7 of the emptying device 6 is shaped as a flat rectangular tube which is closed at one end. The rectangular tubular unloading slide 7 is arranged horizontally and envelops the fixed base 9 of the magazine 5. Flat sides of the unloading slide 7 are arranged on top and at a base 9 of the magazine 5. The unloading slide 7 is movable horizontally and thus transversal to the magazine 5 and along the base 9. A compression coil spring configured as a spring element 11 that is arranged in the unloading slide 7 and supported at the base 9 loads the unloading slide 7 into a starting position illustrated in FIG. 1.

An upper flat side of the unloading slide 7 penetrates the gap 10 between the magazine 5 and its base 9. The upper flat side is not thicker than the closures 8. The upper flat side of the unloading slide 7 includes an ejection opening 12 which corresponds with the closures 8. The ejection opening 12 is sized identical to the closures 8. In the starting position of the unloading slide 7 the ejection opening 12 coincides with the magazine 5 so that the lowest closure 8 out of the magazine 5 is arranged in the ejection opening 12 in the upper flat side of the unloading slide 7. The lower flat side of the unloading slide 7 that is arranged under the base 9 of the magazine 5 also includes an ejection opening 12 which coincides axially with the ejection opening 12 in the upper flat side of the unloading slide 7. The ejection opening 12 in the lower flat side of the unloading slide 7 is greater than the ejection opening 12 in the upper flat side of the unloading slide 7 so that a closure 8 that drops out of the ejection opening 12 in the upper flat side of the unloading slide 7 drops through the ejection opening 12 in the lower flat side of the unloading slide 7 without touching an edge of the ejection opening 12.

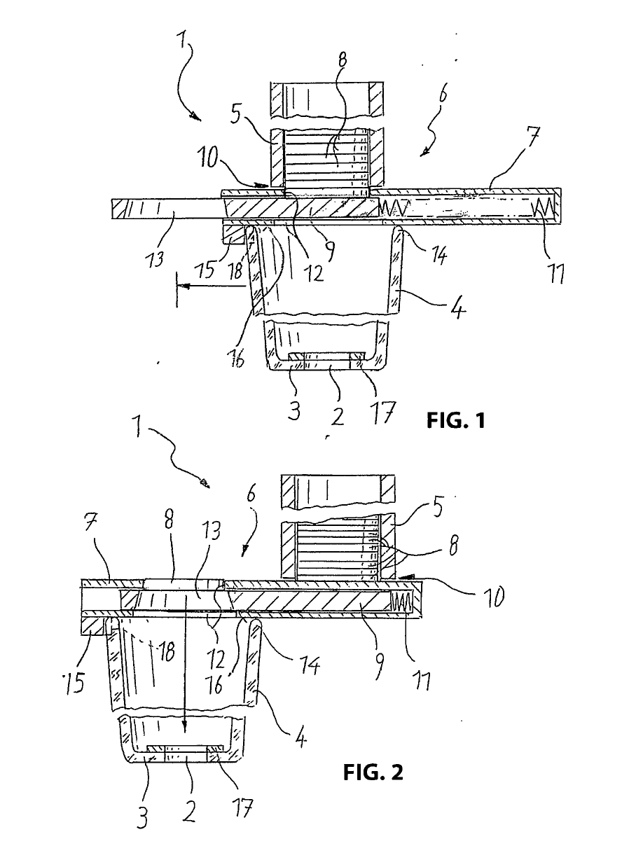

Moving the unloading slide 7 of the emptying device 6 of the arrangement 1 according to the invention from the basic position illustrated in FIG. 1 against a spring force of the spring element 11 into an ejection position illustrated in FIG. 2 pushes the lowest closure 8 of the closures 8 stacked in the magazine 5 through the gap 10 out of the magazine 5 which can be typically considered as moving a closure 8 out of the magazine 5 or unloading the magazine 5. The unloading slide 7 unloads the closures 8 out of the magazine 5 individually and therefore the emptying device 6 can also be considered as an individualizes.

Laterally outside of the magazine 5 the base 9 of the magazine 5 includes a drop through hole 13 which has at least the size of the ejection opening 12 in the upper flat side of the unloading slide 7 and which coincides with the ejection openings 12 of the unloading slide 7 when the unloading slide 7 is moved into the ejection position illustrated in FIG. 2. The lowest closure 8 unloaded from the magazine 5 in the ejection opening 12 in the upper flat side of the unloading slide 7 drops in the ejection position of the unloading slide 7 from the ejection opening 12 in the upper flat side of the unloading slide 7 through the drop hole 13 in the base 9 of the magazine 5 and through the ejection opening 12 in the lower flat side of the unloading slide 7 in a downward direction.

The unloading slide 7 with the beverage container 4 is moved which can also be considered as moving the emptying device 6. The beverage container 4 is open on top, it includes an upper opening that is arranged opposite to the base 3 and the fill in opening 2. The beverage container 4 is arranged under the emptying device 6 of the arrangement 1 according to the invention in that the beverage container is held by hand with an edge 14 enveloping its upper opening against the upper flat side of the unloading slide 7 from below. The beverage container 4 is positioned approximately concentric relative to the ejection opening 12. The positioning is assisted by a driver 15 at a bottom side of the unloading slide 7 wherein the edge 14 of the beverage container 4 enveloping the upper opening contacts the driver laterally. A portion enveloping the ejection opening 12 in the lower flat side of the unloading slide 7 forms a contact surface 16 for the edge 14 enveloping the upper opening of the beverage container 4 at the bottom side of the unloading slide 7.

Moving the beverage container 4 in a movement direction of the unloading slide 7 moves the unloading slide 7 from the starting position into an ejection position. This movement of the beverage container 4 is designated in FIG. 1 with an arrow. The lowest closure 8 thus individually loaded from the magazine 5 drops when the unloading slide 7 reaches the ejection position from the ejection opening 12 in the upper flat side of the unloading slide 7 through the drop hole 13 in the base 9 of the magazine 5 and through the ejection opening 12 in the upper flat side of the unloading slide 7 onto the filling opening 2 in the base 9 of the beverage container 4. Positioning the beverage container 4 approximately concentric to the ejection openings 12 of the unloading slide 7 of the emptying device 6 through lateral contact of the edge 14 of the beverage container 4 at the driver 15 at a bottom at the unloading slide 7 positions the filling opening 2 in the base 3 of the beverage container 4 under the ejection openings 12 of the unloading slide 7 so that the closure 8 as indicated by the arrow in FIG. 2 drops onto the filling opening 2 and closes the filling opening 2.

The driver 15 simultaneously forms a positioning device 18 which positions the beverage container 4 in the movement direction of the unloading slide 7 so that the filling opening 2 in the base 3 of the beverage container 4 is arranged vertically under the ejection opening 12. In the embodiment the driver 15 extends in a circumferential direction of the upper edge 14 of the beverage container 4 so that the upper edge forming the positioning device 18 positions the beverage container 4 also transversal to the movement direction of the unloading slide 7 and thus under the ejection opening 12. It is also possible for example to provide two drivers 15 at two locations at a bottom of the unloading slide 7 that are offset in the circumferential direction of the edge 14 of the beverage container 4 in order to position the beverage container 4 as positioning device transversal to a movement direction of the unloading slide 7 (not illustrated).

A ring magnet 17 is arranged at the base 3 of the beverage container 4 wherein the ring magnet envelops the filling opening 2. The ring magnet 17 magnetically supports the closure 8 that has dropped onto the filling opening 2 so that the filling opening 2 in the base 3 of the beverage container 4 is closed.

Filling the beverage container 4 is not part of the invention and therefore not illustrated. The beverage container 4 can be filled from below through the filling opening 2 in the base 3 of the beverage container 4. Thus, the beverage container 4 is placed onto a hollow shaft which passes through the filling opening 2 and which lifts the closure 8. The hollow shaft includes lateral outlet openings on top through which a liquid flows into the beverage container 4. After filling the beverage container 4 is lifted off from the hollow shaft, wherein the closure 8 moves back onto the ring magnet 17 and closes the filling opening 2.

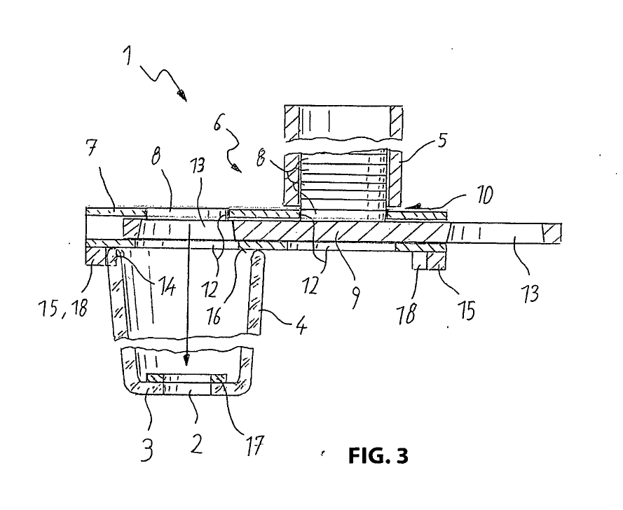

In the subsequent description of FIG. 3 components that are identical to the components in FIGS. 1 and 2 are designated with identical reference numerals. In order to avoid repetition the descriptions of FIGS. 1 and 2 are being referred to in the description of FIG. 3.

In the arrangement of FIG. 3 the unloading slide 7 has no spring element 11 and is slideable back and forth between two end positions. The unloading slide 7 includes two ejection openings 12 in its upper flat side and axially concentric and larger ejection openings 12 in its lower flat side. In a first end position of the unloading slide 7, a first ejection opening 12 coincides with the magazine 5 and in a second end position a second ejection opening 12 coincides with the magazine 5. The respective other ejection opening 12 is arranged laterally adjacent to the magazine 5 above a drop hole 13 of the base 9 of the magazine 5. The base 9 of the magazine 5 includes two drop holes 13 which are laterally offset relative to the magazine 5 in opposite directions in the movement direction of the unloading slide 7.

When the unloading slide 7 is moved from the first end position into the second end position the unloading slide 7 unloads a lowest closure 8 from the magazine 5 in one of its two ejection openings 12 and moves the lowest closure 8 over one of the two drop holes 13 of the base 9. At this location the closure 8 drops out of the ejection opening 12 in the upper flat side of unloading slide 7 through the drop hole 13 in the base 9 of the magazine 5 and through the ejection opening 12 in the lower flat side of the unloading slide 7 onto the filling opening 2 in the base 3 of a beverage container 4 that is arranged under the ejection opening 12 and held by hand in the embodiment as indicated by the arrow in FIG. 3. The unloading slide 7 of the arrangement 1 in FIG. 3 is moved like in FIGS. 1 and 2 with the beverage container 4 that is arranged below the ejection opening 12 of the unloading slide 7 wherein an upper edge 14 of a beverage container 4 contacts a bottom of the unloading slide 7 and laterally contacts the driver 15.

The beverage container 4 is removed and an additional beverage container 4 on whose filling opening 2 no closure 8 is disposed is arranged under the ejection opening 12 of the unloading slide 7 or held under the ejection opening 12 which is arranged under the magazine 5. Together with the additional beverage container 4 the unloading slide 7 is moved in an opposite direction into the end position wherein the unloading slide 7 in turn unloads the lowest closure 8 from the magazine 5 and on the other side drops the lowest closure like before through the drop hole 13 of the base 9 of the magazine 5 and the ejection opening 12 in the lower flat side of the unloading slide 7 onto the filling opening 2 in the base 3 of the beverage container 4.

In FIG. 3 the unloading slide 7 includes a driver 15 for both ejection openings 12 in an upper flat side of the unloading slide, wherein the driver simultaneously forms a positioning device. As illustrated regarding FIGS. 1 and 2 the drivers 15 are used for moving the unloading slide 7 with the beverage container 4 and as a positioning device 18 for positioning the beverage container 4 under a respective ejection opening 12.

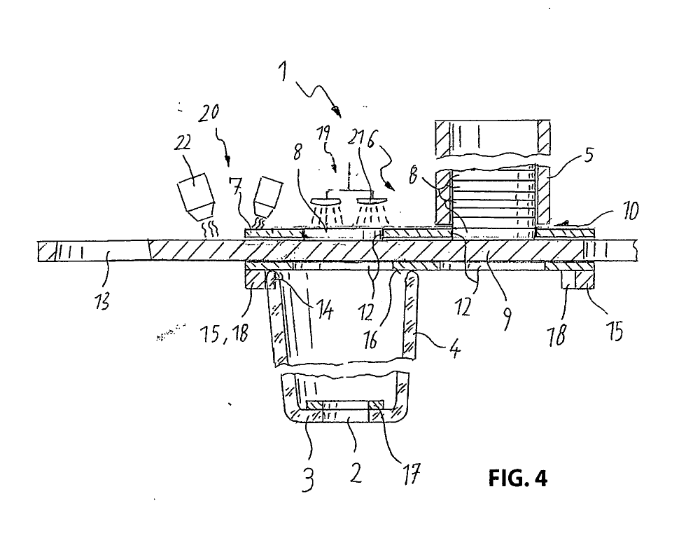

In the arrangement 1 according to the invention illustrated in FIG. 4 the fixed base 9 is extended on both sides of the magazine 5 compared to FIG. 3. Due to space constraints the extension of the base 9 is only depicted on one side (left side in the drawing) and the extension of the base 9 on the opposite side of the magazine 5 is not shown. A cleaning device 19 and a drying device 20 are arranged between the magazine 5 and the drop hole 13 in the fixed base 9. The cleaning device 19 cleans each closure 8 individually with shower heads 21 wherein the cleaning device sprays a cleaning fluid from the shower heads onto each individual closure 8. The drying device 20 dries each closure 8 individually with hot air from hot air blowers 22.

Like in FIG. 3 an unloading slide 7 unloads the closures 8 individually from the magazine 5 in FIG. 4 and moves them when the unloading slide is moved together with the beverage container 4 so that the closures 8 are moved individually on the fixed base 9 of the arrangement 1 through the cleaning device 19 and the drying device 20 to the drop hole 13 in the base 9 so that the respective closure 8 drops downward through the drop hole 13 onto the filling opening 2 in the base 3 of the beverage container 4.

Furthermore the arrangement of FIG. 4 is configured identical and functions in the same way as the arrangement of FIG. 3 so that the description of FIG. 3 is referred to in order to describe FIG. 4 and avoid repetitions. Like or identical components are provided with identical reference numerals.

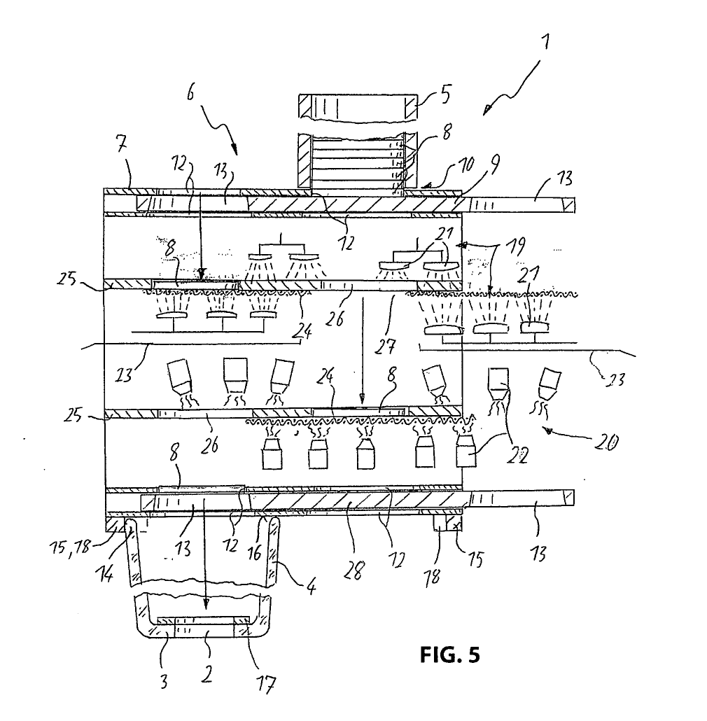

The arrangement 1 according to the invention illustrated in FIG. 5 includes cleaning devices 19 like the arrangement of FIG. 4 and drying devices 20 for the closures 8. Differently from FIG. 4 the arrangement 1 in FIG. 5 is built in different levels, the cleaning devices 19 are not arranged adjacent to the magazine 5 but under the magazine 5 and the drying devices 20 are arranged under the cleaning devices 19.

In the cleaning device 19 under the magazine 5 and also thereunder in the drying device 20 the arrangement 1 includes horizontal fixed grids 24 on which closures 8 are placed individual and are pushed by slides 25 through the cleaning device 19 and drying device 20. The slides 25 are arranged on the grids 24 and are integrally made or permanently connected with the unloading slide 7 so that the slides 25 are moved with the unloading slide 7 when the unloading slide 7 is moved with the beverage container 4. The slides 25 include openings 26 into which the closures 8 fall individually out of the ejection opening 12 of the unloading slide 7 and through the drop hole 13 in the fixed base 3 of the magazine 5. Under the cleaning devices 19 the arrangement 1 includes catch pans 23 which capture and drain the cleaning fluid.

The grid 24 of the cleaning device 19 includes an opening 27 in a center and under the magazine 5 wherein a closure 8 falls through the opening 27 from the cleaning device 19 onto the grid 24 of the drying device 20 arranged thereunder wherein the closure 8 drops further into one of the two openings 26 in the slide 25. The grid 24 of the drying device 20 is short enough so that a closure 8 which is pushed by the slide 25 over an edge of the grid 24 drops through the ejection opening 12 arranged thereunder in the unloading slide 7 and the drop hole 13 in a fixed lower base 28 of the arrangement 1 onto the filling opening 2 in the base 3 of the beverage container 4. The grid 24 of the cleaning device 19 and the drying device 20 facilitate cleaning and drying the closure 8 also from below. As illustrated in FIG. 4 the cleaning device 19 includes shower heads 21 and the drying device 20 includes hot air blowers 22 above and below the respective grid 24.

In order to unload a closure 8 from the magazine 5 the unloading slide 7 with the beverage container 4 held against the unloading slide from below is moved to a side. Thus, an edge 14 of the upper opening of the beverage container 4 contacts the driver 15 and the positioning device 18 of the unloading slide 7. In its ejection opening 12 the unloading slide 7 moves the respective lowest closure 8 out of the magazine 5 on the fixed base 9 of the magazine 5 sideways to the drop hole 13 in the base 9. Through the drop hole 13 the closure 8 drops into the opening 26 of the slide 25 of the cleaning device 19 and onto the grid 24 of the cleaning device 19. During a subsequent opposite movement of the slide 25 with a new beverage container 4 whose edge 14 of its upper opening contacts the opposite driver 15 and the positioning device 18 of the unloading slide 7 so that the next closure 8 is unloaded from the magazine 5 on the opposite side the closure 8 is moved on the grid 24 of the cleaning device 19 between the shower heads 21 and thus cleaned.

The closure 8 drops through the opening 27 in the grid 24 of the cleaning device 19 downward into the opening 26 of the slide 25 of the drying device 20 and onto its grid 24. Provided with another new beverage container 4 the unloading slide 7 is moved in the opposite direction again, unloads a closure 8 from the magazine 5 and moves or feeds the closure 8 through the cleaning device 19. Simultaneously the slide 25 of the drying device 20 moves the closure 8 through the drying device 20 and at its end over the edge of the grid 24 where the closure 8 drops through an ejection opening 12 in a bottom of the unloading slide 7 and a drop hole 13 in a fixed base 28 at a bottom of the arrangement 1 onto the filling opening 2 in the base of the beverage container 4 and closes the filling opening.

Furthermore reference is made to FIGS. 1-4, in particular FIG. 4 or FIGS. 3 and 4 regarding the description of FIG. 5.

### REFERENCE NUMERALS AND DESIGNATIONS

1 arrangement

2 filling opening

3 base

4 beverage container

5 magazine

6 emptying device

7 unloading slide

8 closure

9 base

10 gap

11 spring element

12 ejection opening

13 drop hole

14 edge

15 driver

16 contact surface

17 ring magnet

18 positioning device

19 cleaning device

20 drying device

21 shower head

22 hot air blower

23 catch pan

24 grid

25 slide

26 opening

27 opening

28 base

What is claimed is:

1. An arrangement for closing a filling opening in a base of a beverage container that is open on top, the arrangement comprising:
a magazine which includes at least one closure for the filling opening;
an emptying device which unloads an individual closure from the at least one closure from the magazine; and
the beverage container,
wherein the beverage container is arranged so that an upper opening of the beverage container is positioned under the emptying device so that the beverage container is in contact with the emptying device so that the emptying device is displaceable together with the beverage container so that the emptying device unloads the individual closure from the magazine and the individual closure drops into the beverage container under the emptying device.

2. The arrangement according to claim 1, wherein an ejection opening of the emptying device is arranged above the filling opening in the base of the beverage container arranged under the emptying device in an ejection position of the emptying device.

3. The arrangement according to claim 1,
wherein the emptying device includes an unloading slide which is in contact with the beverage container that is arranged under the emptying device and in contact with the unloading slide, and
wherein the unloading slide is displaceable and extracts the individual closure from the magazine during a displacement of the unloading slide from a starting position to an ejection position.

4. The arrangement according to claim 3, wherein the unloading slide includes a contact surface for an edge of the upper opening of the beverage container at a bottom side of the unloading slide.

5. The arrangement according to claim 3, wherein the unloading slide is rectangular and tubular and a base of the magazine that is fixed relative to the magazine is arranged in the unloading slide.

6. The arrangement according to claim 3,
wherein the unloading slide includes a first ejection opening for the individual closure for the filling opening of the beverage container, and
wherein the filling opening coincides in a starting position with an outlet opening of the magazine and is arranged above the filling opening in the base of the beverage container arranged under the unloading slide.

7. The arrangement according to claim 6,
wherein the unloading slide includes the first ejection opening and a second ejection opening respectively configured for the individual closure for the filling opening of the beverage container,
wherein the first ejection opening coincides with the outlet opening of the magazine and the second ejection opening is laterally offset from the magazine in an ejection position when the unloading slide is in a first position that is displaced in a first direction, and
wherein the second ejection opening coincides with the outlet opening of the magazine and the first ejection opening is laterally offset from the magazine in an ejection position when the unloading slide is in a second position that is displaced in a second direction.

8. The arrangement according to claim 1, wherein the emptying device includes a driver at a bottom of the emptying device at which the beverage container contacts laterally in order to displace the emptying device.

9. The arrangement according to claim 1,
wherein the emptying device includes a positioning device at a bottom of the emptying device, and
wherein the positioning device positions the beverage container with respect to a first ejection opening or a second ejection opening of the emptying device so that the filling opening in the base of the beverage container is arranged under the first ejection opening or the second ejection opening.

10. The arrangement according to claim 1, wherein the arrangement includes a cleaning device or a drying device for the individual closure.

11. The arrangement according to claim 1, wherein the beverage container is held by hand under the emptying device.

12. The arrangement according to claim 1, wherein the individual closure is magnetically supported on the filling opening in the base of the beverage container.
